(19) United States
(12) Patent Application Publication
(10) Pub. No.: US 2009/0219988 A1
(43) Pub. Date: Sep. 3, 2009

(54) METHODS OF ENCODING AND DECODING AN IMAGE OR A SEQUENCE OF IMAGES, CORRESPONDING DEVICES, COMPUTER PROGRAM AND SIGNAL

(75) Inventors: Nathalie Cammas, Sens De Bretagne (FR); Stephane Pateux, Rennes (FR); Isabelle Amonou, Thorigne-Fouillard (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/159,958

(22) PCT Filed: Dec. 26, 2006
(86) PCT No.: PCT/EP2006/070210

§ 371 Date: Dec. 3, 2008

(30) Foreign Application Priority Data
Jan. 6, 2006 (FR) 06/00139

(51) Int. Cl. H04N 7/26

(52) U.S. Cl. 375/240.01; 375/E07.026

(57) ABSTRACT

A method is provided of coding an image or a sequence of images, generating a data stream, each image being split into at least two images blocks, wherein each of which is associated a transformed block comprising a set of coefficients. The coefficients of a transformed block are distributed into group(s) of coefficients according to a predetermined path for reading the transformed blocks. The method includes, for each of the transformed blocks: a step of coding a series of coefficients corresponding to at least one group of coefficients, the series being determined on the basis of a type of series of coefficients that is selected from at least two possible types, and a step of inserting into the data stream a cue representative of the type of series of coefficients that is selected for the image or the sequence of images, or for a portion of the image.

### CROSS-REFERENCE TO RELATED APPLICATIONS

This Application is a Section 371 National Stage Application of International Application No. PCT/EP2006/070210, filed Dec. 26, 2006 and published as WO 2007/077178A1 on Jul. 12, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the encoding and decoding of images or image sequences.

More specifically, the disclosure relates to the encoding and decoding of coefficients representing one or more images derived from a conversion of the image into one or more blocks.

The disclosure can be applied especially but not exclusively to the encoding and decoding of scalable images or image video sequences having a hierarchical structure in layers or levels.

According to this application, the disclosure is situated in a context of scalable video encoding based on motion-compensated temporal transformation and layered representation with inter-layer prediction.

### BACKGROUND OF THE DISCLOSURE

For the sake of simplicity and clearness, a detailed description is provided below solely of the prior-art pertaining to the encoding and to the decoding of images or scalable image sequences.

General Principle of Scalable Video Encoding

There are many data transmission systems today that are heterogeneous in the sense that they serve a plurality of clients having a very wide variety of types of data access. Thus, the worldwide network, the Internet, for example is accessible both from a personal computer (PC) type terminal and from a radio telephone. More generally, the network access bandwidth, the processing capacities of the client terminals and the size of their screens varies greatly from one user to another. Thus, a first client may for example access the Internet from a powerful PC with an ADSL (Asymmetric Digital Subscriber Line) bit rate at 1024 kbits/s while a second client might try to access the same data at the same time from a PDA (Personal Digital Assistant) type terminal connected to a modem at low bit rate.

Now, most video encoders generate a single compressed stream corresponding to the totality of the encoded sequence. Thus, if several clients wish to exploit the compressed file for decoding and viewing, they will have to download or stream the full compressed file.

It is therefore necessary to propose a data stream to these various users that is adapted in terms of bit rate as well as image resolution to their different requirements. This necessity is all the greater for applications accessible to clients having a wide variety of capacities of access and processing, especially for applications related to:
video on demand (VOD) services accessible to UMTS (Universal Mobile Telecommunications Service) (type) radio communications terminals, PCs or television terminals with ADSL access, etc;
session mobility (for example a resumption on a PDA of a video session begun on a television set or on a UMTS mobile of a session begun on the GPRS (General Packet Radio Service);
session continuity (in a context of sharing the bandwidth with the new application);
high-definition television in which the unique video encoding should make it possible to serve clients having standard definition SD as well as to clients having a high-definition HD terminal;
video-conferencing in which a unique encoding must meet the requirements of clients having both UMTS access and Internet access;
etc.

To meet these different requirements, scalable image encoding algorithms have been developed, enabling adaptable quality and variable space-time resolution. In these techniques, the encoder generates a compressed stream with a hierarchical layered structure in which each of the layers is nested into a higher-level layer. For example, a first data layer conveys a stream at 256 bits/s which could be decoded by a PDA type terminal, and a second complementary data layer conveys a stream with higher resolution at 256 kbits/s which can be decoded as a complement to the first stream by a more powerful PC-type terminal. The bit rate needed to convey these two nested layers in this example is 512 kbits/s.

Encoding algorithms of this kind are thus very useful for all applications for which the generation of a single compressed stream, organized in several layers of scalability, can serve several customers having different characteristics.

Some of these scalable video encoding algorithms are now being adopted by the MPEG (Moving Picture Expert Group) standard in the context of the joint video team (JVT) working group set up between the ITU (International Telecommunications Union) and the ISO (International Organization for Standardization).

In particular, the model chosen recently by the JVT SVC (Scalable Video Encoding) working group is called JSVM (Joint Scalable Video Model) and is based on a scalable encoder based on AVC (Advanced Video Coding) type solutions with inter-layer prediction and temporal decomposition into hierarchical B images. This model is described in greater detail in the document JVT-Q202 by J. Reichel, M. Wien and H. Schwarz, <<Joint Scalable Video Model JSVM-4>>, October 2005 Nice. The JVT working group has the goal especially of proposing a standard for the supply of streams with medium-grain scalability in the time, space and quality dimensions.

The JSVM Encoder

Main Characteristics of the Encoder

FIG. 1 illustrates the structure of a JSVM encoder of this kind having a pyramidal structure. The video input components 10 undergo dyadic sub-sampling (2D space decimation referenced 11).

Each of the sub-sampled streams then undergoes a temporal decomposition 12 of the hierarchical B images type. A low-resolution version of the video sequence is encoded up to a given bit rate R_r0_max which corresponds to the decodable maximum bit rate for the low spatial resolution r0 (this low resolution version is encoded in basic layer with a bit rate R_r0_min and enhancement layers until the bit rate R_r0_max is attained; this basic level is AVC compatible).

The higher layers are then encoded by subtraction from the previous rebuilt and over-sampled level with encoding of the residues in the form of:
a basic level;
as the case there may be one or more enhancement levels obtained by multi-path encoding of bitmaps (here below called fine grain scalability). The prediction residue is encoded up to a bit rate R_ri_max which corresponds to the maximum bit rate decodable for the resolution ri.

More specifically, the hierarchical B image type filtering units 12 deliver motion information 16 supplied to a motion encoding block 13-15 and textural information 17 supplied to an inter-layer prediction module 18. The predicted data output from the inter-layer prediction module 18 feed to a conversion and entropic encoding block 20 which works at the refinement levels of the signal. The data coming from this block 20 is used especially to obtain a 2D spatial interpolation 19 from the lower level. Finally, a multiplexing model 21 orders the different sub-streams generated in a general compressed data stream.

Encoding by Progressive Quantification

It can be noted especially that the encoding technique used by the JSVM encoder is a progressive quantification technique.

More specifically, this technique consists first of all in quantifying the different coefficients representing data to be transmitted with a first coarse quantification step. Then, the different coefficients are rebuilt and the difference between the value of the rebuilt coefficient and the quantified value is computed.

According to this technique of progressive quantification, this difference is then quantified with a second quantification step which is finer than the first step.

Thus, the procedure is continued iteratively with a certain number of quantification steps. The result of each quantification step is called an “FGS Pass”.

More specifically again, the quantified coefficients are encoded in two passes, at each quantification step:
a first significance pass used to encode the new significant coefficients, i.e. those that have been encoded with zero value at the preceding quantification step. For these new significant coefficients, the sign of the coefficient and its amplitude are encoded.
a second refinement pass, enabling the refining/encoding of the coefficients that were already significant at the previous quantification step. For these coefficients, a refinement value 0, +1 or −1 is encoded.

It may be recalled especially that a significant coefficient is a coefficient whose encoded value is different from zero.

Cyclical Encoding of the FGS Layers

For a JSVM type encoder, the images to be encoded classically comprise three components. A luminance component and two chrominance components, each typically sized ¼ of the luminance component (i.e. with a width and a height that are twice as small). It may be recalled that it is also possible to process images that have only one luminance component.

Classically, the images are subdivided into macro-blocks sized 16×16 pixels, each macro-block being then re-subdivided into blocks. For the luminance component, the encoding of the refinement layers is then done on 4×4 pixel blocks or else on 8×8 pixel blocks. For the chrominance components, the encoding of the refinement layers is done on 4×4 pixel blocks.

Referring to FIG. 2A, an explanation is given of the “zigzag” order of the scan of the coefficients to encoder block. This order can be explained by the scheduling of the spatial frequencies in a block.

More specifically, the first coefficient of the block corresponds to a low frequency (coefficient DC of the discrete cosine transform DCT), and represents the most important piece of information of the group. The other coefficients correspond to the high frequencies (AC coefficients of the discrete cosine transform DCT), the energy of the high frequencies decreasing horizontally, vertically and diagonally.

Thus, following the sense of the zigzag scan illustrated with reference to FIG. 2A, it is seen to it that the decrease of the high frequencies is tracked. Thus, a high probability is obtained of having coefficients that are increasingly smaller, or even equal to zero.

More specifically, to encode a coefficient, the encoding is performed on significance information, making it possible to find out whether a coefficient is a significant or non-significant coefficient, and the sign and the amplitude of the coefficient if it is a significant coefficient.

Classically, the encoding of the coefficients is done by means of an encoding in ranges (i.e. an encoding in which all the coefficients having a quantified zero value are grouped together).

In other words, to encode a “range” of coefficients, first of all the significance information of all the remaining non-significant coefficients in the zigzag order are encoded until a newly significant coefficient is obtained. Then, the newly significant coefficient is encoded. More specifically, the terms “range” or “group” are understood to mean a group of coefficients whose positions are consecutive and contained in an interval that begins either at the start of a block or after the position of a significant coefficient and which finishes after the next significant coefficient if we consider an encoding (or decoding) significant pass. It is possible especially in this case to use the term “significance group”. If we consider an encoding (or decoding) refining pass, the terms “range” or “group of coefficients” are understood to mean only the coefficient to be refined. It is possible in this case to use the term “refining group”.

In other words, the encoding of a range is defined as the encoding of a newly significant coefficient and of all the remaining non-significant coefficients placed before it if the operation is in a significance pass and, as in the case of the encoding of a refinement of an already significant coefficient, if the operation is in a refinement pass.

For example, to encode the block illustrated in FIG. 2B, the following notations are used:
S to indicate that a coefficient is a significant coefficient;
NS to indicate that a coefficient is a non-significant coefficient;
LS to indicate whether the last significant coefficient of the block has just been encoded or not. More specifically, LS can take two values. For example, if LS=1, it means that this coefficient is the last significant coefficient of the block: all the coefficients positioned after the last significant coefficient are non significant. Thus the encoding of the significance of all these non-significant coefficients is avoided.

Thus, referring to FIG. 2B, the encoding is as follows: NS, NS, NS, S, sign of the significant coefficient, value (or amplitude) of the significant coefficient, LS, NS, NS, NS, S, sign of the significant coefficient, the value (or amplitude) of the significant coefficient LS.

If, during on the scan of in this path of the block, coefficients that have already been significant at the previous quantification step (i.e. at the previous iteration) are reached, nothing is encoded for these coefficients during the significance pass.

It may be recalled that the encoding of the refinement layers, in a classic JSVM encoder such as the one defined in the document <<Scalable Video Coding Joint Working Draft 4>>, October 2005, Nice, Joint Video Team of the ISO/IEC MPEG and ITU-T VCEG, JVT-Q201 is done iteratively.

Thus, at each iteration, all the macro-blocks of the image are scanned. For each macro-block, all the luminance blocks and chrominance blocks are scanned. For each luminance and chrominance block, a range is encoded according to the classic technique then the operation passes to the next block and so on and so forth for all the blocks of the macro-block.

When all the macro-blocks have been scanned, the operation passes to the next iteration in which, for each block, the second range of each block is encoded. Thus, the iteration is continued until all the significant coefficients of all the blocks of the image are encoded.

Thus, for the example illustrated with reference to FIG. 2B, two iterations are necessary to encode all the significant coefficients of the block.

It must be noted that when a significant coefficient is encoded, it happens that actually several coefficients are encoded, these coefficients corresponding to the non-significant coefficients placed before the significant. Thus, the encoding of the second significant coefficient of a block does not always mean that the coding is done effectively on the coefficient placed in second position in the block in the zigzag order. Similarly, the nth significant coefficient to be encoded of a block is not necessarily positioned at the same place for all the blocks.

Finally, when all the significant coefficients of the image are encoded, the refined coefficients are encoded at the next iteration.

Each macro-block of the image and then each luminance block and chrominance block of the macro block is scanned. For each block, the first coefficient of the block is studied. If the coefficient had already been significant at the preceding quantification step (i.e. at the preceding iteration), its refinement is encoded. If not, nothing is encoded. The operation then passes to the next block and so on and so forth until all the blocks are scanned.

At the next iteration, the refinement of the second coefficient to be refined of all the blocks is encoded. Thus, these operations are reiterated until all the refinements of the coefficients to be refined are encoded.

The operation also uses a parameter enabling the control of the interlacing of the encoding of the coefficients of the chrominance and luminance components. Thus, for a given iteration, it is possible to encode luminance coefficients only or else luminance and chrominance coefficients.

This technique of encoding by iteration is thus used to interlace the coefficients of the refinement layer and ensure better quality of rebuilding of an image, especially if the refinement layer is truncated.

Syntax of the SVC Stream

Referring now to FIG. 3, we present the structure of the SVC stream obtained at output of the multiplexing module 21 of FIG. 1.

The compressed data stream at output of the encoder is organized in Access Units or AUs, each corresponding to a time instant T and comprising one or more elementary access data units for the network (packet) called Network Abstraction Layer Units or NALUs.

It may be recalled that each NALU is associated with an image or an image portion grouping a set of macro-blocks (also called slices) derived from the space-time decomposition, a space resolution level and a quantification level. This structuring in elementary units is used to achieve a matching in terms of bit rate and/or space-time resolution in eliminating the NALU that have excessively great spatial resolution or time frequency resolution or encoding quality.

More specifically, in the context presented here, each FGS pass (or refinement layer) of an image is inserted in a NALU.

FIG. 3 thus illustrates the access units AU1 31 corresponding to the time T0 and AU2 32 corresponding to the time T1. More specifically, the access unit AU31 comprises six NALUs 311 to 316 corresponding to the instant T0. The first NALU 311 represents a space level S0 and an FGS/CGS level E0. The second NALU 312 represents a space level S0 and an FGS/CGS level E1. Finally, the last NALU 316 represents a space level S2 and an FGS/CGS level E1.

Drawbacks of the Prior-Art

One drawback of this prior-art encoding technique is that, to attain a target rate, it may be necessary to truncate the constituent data of the packet also called NALUs.

Now, the classic technique for encoding refinement layers by iteration, which enables the interlacing of the coefficients of the refinement layer, implies high complexity in the decoder although, as a trade-off, it offers higher rebuilding quality, when the refinement layers are truncated either at the encoder or at transmission, than with a method that processes all the macro-blocks of an image sequentially.

Indeed, the interlacing of the coefficients of each block implies frequent changes in decoding context, hence frequent changes in the information contained in the cache of the computer, leading to increased complexity at the level of the decoding.

It can also be noted that the truncation of the refinement layers is not always necessary.

Indeed, although it can be used to attain a target bit rate for an encoded stream by truncating all the refinement layers with the same ratio, the use of quality levels of the JSVM encoder, as presented by I. Amonou, N. Cammas, S. Kervadec, S. Pateux in the document <<JVT-Q081 Layered quality opt of JSVM3 and closed-loop>> enables the ordering of the refinement layers of the images relative to one another and the attaining of a target bit rate without truncating the refinement layers while at the same time improving quality as compared with the case where the refinement layers are truncated.

In this context, encoding by iteration does not give any compression gain but preserves higher complexity.

### SUMMARY

An aspect of the disclosure relates to a method for the encoding of an image or a sequence of images, generating a data stream, each image being subdivided into at least two image blocks, with each one of which is associated a transformed block comprising a set of coefficients, the coefficients of a transformed block being distributed in a group or among groups of coefficients according to a predetermined grouping criterion and a predetermined scan path for reading the transformed blocks.

According to an embodiment of the invention, the encoding method comprises the following for each of the transformed blocks: a step for encoding a series of coefficients corresponding to at least one group of coefficients, said series being determined as a function of a type of series of coefficients selected from among at least two possible types, including:
a first type of series according to which the series of coefficients comprises a predetermined number M of groups of coefficients,
a second type of series according to which, with a predetermined maximum position N in the scan path being identified, the series comprise the group including the maximum position N and all the preceding groups along the scan path, if there are any,
   and a step of insertion into the data stream of a piece of information representing the type of series of coefficients selected for the image or the sequence of images or for a portion of the image.

Thus, an embodiment of the invention relies on a wholly novel and inventive approach to the selection of a type of series of coefficients and to the encoding of a series of coefficients determined on the basis of the selected type, and the insertion into the data stream of the selected type of series so that, at the level of the decoding of the data stream, a decoder can read the type of series of coefficients used when encoding and adapt itself automatically to the encoding used to reduce the complexity of the decoding.

The series of coefficients to be encoded may, according to a first type of series, comprise a predetermined number M of groups of coefficients. Thus, the series may correspond to a single group of coefficients, a predetermined number of groups of coefficients (greater than or equal to two) or again to all the coefficients of the block considered.

According to a second type of series, the series may comprise the group comprising the coefficient positioned at the position N, according to a predetermined read scan path, and all the preceding groups, according to the predetermined read scan path, the group comprising the coefficient positioned at the position N, if any.

Advantageously, the read scan path is the zigzag path as described with reference to FIG. 2A.

Preferably, the data stream has a hierarchical structure in nested data layers at successive refinement levels, and the encoding method implements an iterative encoding, each of the iterations corresponding to one of the levels and implementing the encoding step.

An embodiment of the invention is thus particularly well suited to the encoding of scalable video signals.

In particular, for the second type of series:
when the series comprising the group including the maximum position N has been encoded at a preceding iteration, the series is empty,
when the series comprising the group including the maximum position N has not been encoded at a preceding iteration, the series comprises the group including the predetermined maximum position and all the preceding groups along the scan path that do not belong to a series already encoded at a preceding iteration, if there are any.

It is thus possible, during the following iterations, to take account of the coefficients already encoded during preceding iterations. An empty series thus indicates the fact that, at a preceding iteration, the groups included in the series had already been encoded.

According to an advantageous characteristic of an embodiment of the invention, each of the iterations implements at least one of the following passes:
a significance pass,
a refinement pass,
   the encoding step applying to the pass or passes implemented,
   and a parameter indicating the type of pass or passes implemented accompanies the information representing the type of series of coefficients.

It is thus possible to encode various pieces of information in the stream, and these pieces of information will enable the decoder to easily adapt to the encoding technique used, and therefore simplify the complexity of decoding.

In particular, when the pass is a significance pass, the predetermined grouping criterion defines a group as a set of successive non-significant coefficients terminating with the first significant coefficient encountered along the read scan path. When the pass is a refinement pass, the predetermined grouping criterion defines the group as a unique significant coefficient.

Advantageously, the piece of information representing the type of series of coefficients is accompanied by a piece of information on implementation, comprising a vector that defines the value of the number M or the position N for each iteration.

This vector can be known by default, hence determined beforehand or directly encoded in the stream. This vector thus enables a definition of the positions N of the coefficients to be attained at each iteration. For example, this vector is equal to [1,3,10,16] for a block sized 4×4 or [3,10,36,64] for a block sized 8×8.

The piece of information on application may also specify the number of ranges to be encoded (defining the number of groups M).

According to an advantageous characteristic of an embodiment of the invention, a source image is decomposed into at least two components to be encoded, and the encoding is applied to each of the components.

For example, an image comprises one luminance component and two chrominance components, and the encoding is applied to each of these three components.

An embodiment of the invention also concerns a device for the encoding of an image or a sequence of images, generating a data stream, each image being subdivided into at least two image blocks, with each one of which is associated a transformed block comprising a set of coefficients, the coefficients of a transformed block being distributed in a group or among groups of coefficients according to a predetermined grouping criterion and a predetermined scan path for reading the transformed blocks.

According to an embodiment of the invention, such a device comprises: means of encoding a series of coefficients corresponding to at least one group of coefficients, said series being determined as a function of a type of series of coefficients selected from among at least two possible types, including:
a first type of series according to which the series of coefficients comprises a predetermined number M of groups of coefficients,
a second type of series according to which, with a predetermined maximum position N in the scan path being identified, the series comprises the group including the maximum position N and all the preceding groups along the scan path, if there are any,
   and means of insertion into the data stream of a piece of information representing the type of series of coefficients selected for the image or the sequence of images or for a portion of the image.

Such a device can especially implement the encoding method described here above.

In particular, the data stream can have a hierarchical structure in nested data layers at successive refinement levels, and the encoding means can implement an iterative encoding, each of the iterations corresponding to one of the levels (and implementing the encoding step).

An embodiment of the invention also concerns a method for the decoding of a data stream representing an image or a sequence of images, each image being subdivided into at least two image blocks, with each one of which is associated a transformed block comprising a set of coefficients, the coefficients of a transformed block being distributed in a group or among groups of coefficients according to a predetermined grouping criterion and a predetermined scan path for reading the transformed blocks.

According to an embodiment of the invention, such a decoding method comprises:

a step of reading a type of series of coefficients applied to the image or sequence of images, or an image portion, from at least two possible types, including:
a first type of series according to which the series of coefficients comprises a predetermined number M of groups of coefficients,
a second type of series according to which, with a predetermined maximum position N in the scan path being identified, the series comprises the group including the maximum position N and all the preceding groups along the scan path, if there are any,
   and a decoding step taking account, for each transformed block, of a series of coefficients according to the type of series of coefficients delivered by the read step.

Such a decoding step is especially suited to receiving a data stream encoded according to the encoding method described here above.

Thus, the data stream can have a hierarchical structure in nested data layers at successive refinement levels.

In particular, if the stream has undergone an iterative encoding, each of the iterations corresponding to one of the levels, the following are had for the second type of series:
when the series comprising the group including the maximum position N has been encoded at a preceding iteration, the series is empty,
when the series comprising the group including the maximum position N has not been encoded at a preceding iteration, the series comprises the group including the predetermined maximum position and all the preceding groups along the scan path that do not belong to a series already encoded at a preceding iteration, if there are any.

An embodiment of the invention also concerns a device for the decoding of data stream representing an image or a sequence of images, each image being subdivided into at least two image blocks, with each one of which is associated a transformed block comprising a set of coefficients, the coefficients of a transformed block being distributed in a group or among groups of coefficients according to a predetermined grouping criterion and a predetermined scan path for reading the transformed blocks.

According to an embodiment of the invention, such a decoding device comprises:

means of reading a type of series of coefficients applied to the image or sequence of images, or an image portion, from at least two possible types, including:
a first type of series according to which the series of coefficients comprises a predetermined number M of groups of coefficients,
a second type of series according to which, with a predetermined maximum position N in the scan path being identified, the series comprises the group including the maximum position N and all the preceding groups along the scan path, if there are any,

and decoding means taking account, for each transformed block, of a series of coefficients according to the type of series of coefficients delivered by the read step.

Such a device can especially implement the decoding method described here above. It is consequently adapted to receiving a data stream encoded by the encoding device described here above.

The data stream may especially have a hierarchical structure in nested data layers at successive refinement levels.

An embodiment of the invention also pertains to a signal representing a data stream, representing an image or a sequence of images, each image being subdivided into at least two image blocks, with each one of which is associated a transformed block comprising a set of coefficients, the coefficients of a transformed block being distributed in a group or among groups of coefficients according to a predetermined grouping criterion and a predetermined scan path for reading the transformed blocks.

According to an embodiment of the invention, such a signal carries a piece of information representing a type of series of coefficients applied to the image or sequence of images, or to an image portion, from at least two possible types, including:
a first type of series according to which the series of coefficients comprises a predetermined number M of groups of coefficients,

a second type of series according to which, with a predetermined maximum position N in the scan path being identified, the series comprises the group including the maximum position N and all the preceding groups along the scan path, if there are any,

Such a signal may especially comprise a data stream encoded according to the encoding method described here above. This signal could of course comprise the different characteristics pertaining to the encoding method according to an embodiment of the invention.

Thus the data stream may especially present a hierarchical structure in nested data layers at successive refinement levels, said stream having undergone an iterative encoding, each of the iterations corresponding to one of said levels. In this case, for the second type of series:
when the series comprising the group including the maximum position N has been encoded at a preceding iteration, the series is empty,
when the series comprising the group including the maximum position N has not been encoded at a preceding iteration, the series comprises the group including the predetermined maximum position and all the preceding groups along the scan path that do not belong to a series already encoded at a preceding iteration, if there are any.

Finally, an embodiment of the invention pertains to a computer program product downloadable from a communications network and/or stored in a computer-readable carrier and/or executable by a microprocessor comprising program code instructions for the implementation of the encoding method as described here above and a computer program product downloadable from a communications network and/or stored in a computer-readable carrier and/or executable by a microprocessor comprising program code instructions for the implementation of the encoding method as described here above.

### BRIEF DESCRIPTION OF THE DRAWINGS

Other features and advantages shall appear from the following description of a preferred embodiment, given by way of a simple illustrative and non-exhaustive example and from the appended drawings, of which:

FIG. 1, already described with reference to the prior art, presents a JSVM type encoder;

FIGS. 2A and 2B, also presented with reference to the prior art, illustrate the zigzag path of the coefficients of the blocks forming an image;

FIG. 3, also presented with reference to the prior art, describes the structure of an SVC type stream according to the prior art;

FIG. 4 presents the general principle of the encoding method according to an embodiment of the invention;

FIGS. 5A to 5D illustrate different possible types of series for the encoding of the coefficients of a block according to the method of FIG. 4;

FIG. 6 presents the frequency bands of a default vector considered for a block sized 4×4 according to one variant of the invention;

FIG. 7 describes the general principle of the decoding method according to an embodiment of the invention;

FIGS. 8 and 9 respectively show the simplified hardware structure of an encoding device and a decoding device according to an embodiment of the invention.

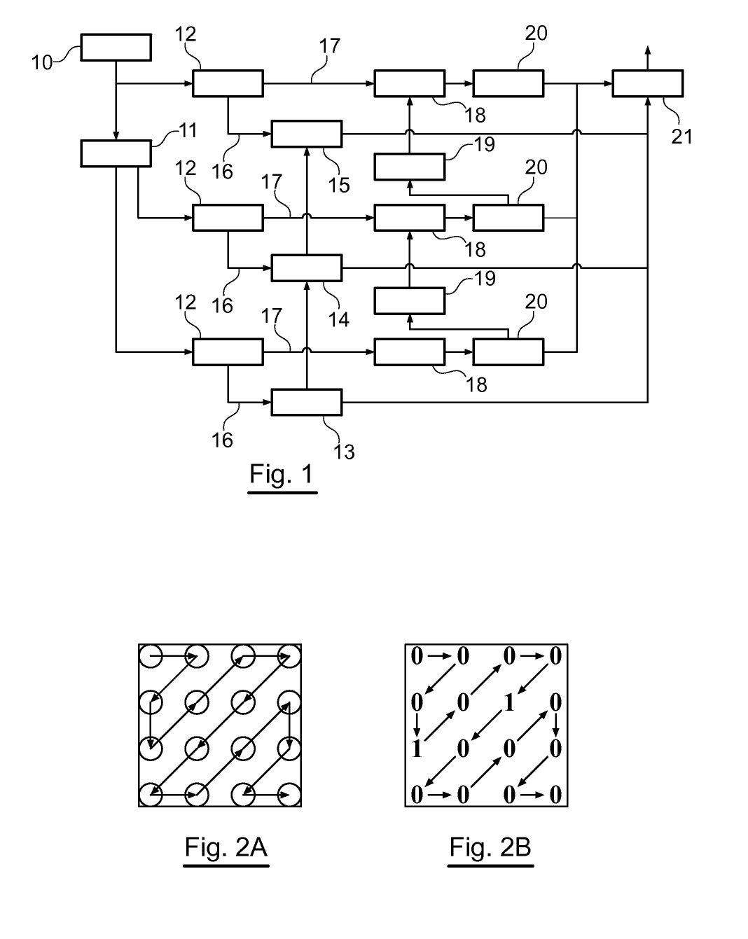

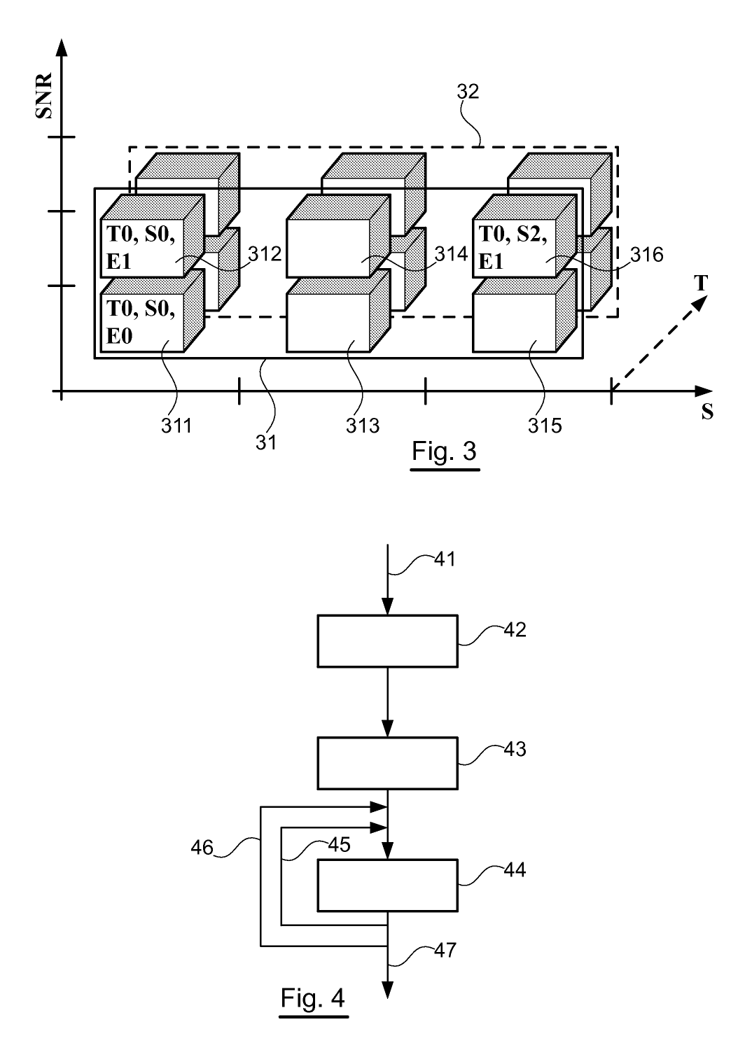

### DETAILED DESCRIPTION OF ILLUSTRATIVE EMBODIMENTS

The general principle of an embodiment of the invention relies on the encoding of a series of coefficients among a set of coefficients representing an image, the serie to be encoded being determined as a function of a type of series of coefficients selected from among at least two types.

According to an embodiment of the invention, the description considers an image subdivided into at least two blocks, with each of which a transform block is associated, for example by means of a discrete cosine transform (DCT). For the sake of simplicity and for the clearness of the description, the term “block” is understood here below to mean a block derived from the subdivision and transformation of the image.

Furthermore, for the sake of simplification and clarity, a detailed description is provided here below of only one preferred embodiment of the invention enabling the encoding and decoding of images or of scalable image sequences. Those skilled in the art will easily extend this teaching to the encoding and decoding of non-scalable image sequences or images.

The encoding method according to this preferred embodiment of the invention is advantageously an iterative method which, at each iteration, encodes a level of the hierarchical structure in nested data layers generating data streams.

Thus, at each iteration, the image or the images (or the image portions) are scanned block by block and at least certain coefficients of each of the blocks are encoded according to the type of series of coefficients selected from among at least two possible types.

According to this preferred embodiment of the invention, the coefficients can be encoded in one or two passes at each iteration according to a significance pass enabling the encoding of new significant coefficients, i.e. those that were encoded with a zero value at the previous iteration and/or according to a refinement pass enabling the refinement/encoding of the coefficients that were already significant at the previous iteration.

The term “group” (or range) of coefficients is understood to mean:
a group of coefficients whose positions are consecutive and contained in an interval that starts either at the start of a block or after the position of a significant coefficient and finishes after the next significant coefficient if we consider a significant encoding (or decoding) pass,
the sole coefficient to be refined if we consider an encoding (or decoding) refinement pass.

The term “significant group” refers especially to a group obtained during a significance pass and the term “refinement group” refers to a group obtained during a refinement pass.

Here below referring to FIG. 4, we present the general principle of the encoding method according to this preferred embodiment of the invention.

According to this preferred embodiment, the input video components 41 (image, image sequences, or image portions) first of all undergo a processing operation 42 by which they are subdivided into at least two blocks and by which each of these blocks has a transform block associated with it comprising a set of coefficients.

During a following selection step 43, a type of series of coefficients is chosen from among at least two possible types.

More specifically, the type of series of coefficients is chosen from among several possible types, including a first type according to which a series of coefficients corresponds to M groups of coefficients where M is a predetermined integer and a second type according to which a series comprises a group including the coefficient positioned at a maximum predetermined position N and all the groups preceding this group are in the zigzag read scan path, if there are any.

More specifically, it is assumed that when the series comprising the group including the coefficient localized at the position N has already been encoded at the previous iteration, the series considered at the current iteration is zero. By contrast, when the series comprising the group including the coefficient located at the position N has not already been encoded at a preceding iteration, the series considered at the current iteration comprises a group including the coefficient positioned at the position N and all the groups preceding this group in the zigzag read scan path, if there are any.

The number N thus corresponds to a position in the block considered, followed by the zigzag scan path defined as a function of the iteration and given by a vector that is known by default or encoded in the stream. For example, this default vector is equal to [1,3,10,16] for a block sized 4×4 or [3,10,36,64] for a block sized 8×8.

According to this preferred embodiment of the invention, a series may thus correspond:
to a group of coefficients (here below this encoding, according to which M=1, is denoted “mode 0”);
to the set of coefficients of the block considered (this encoding is denoted “mode 1”, here below);
to a set of groups defined as a function of a maximum position N as a function of the iteration (this encoding is here below denoted “mode 2”); or again
to M groups of coefficients (this encoding is denoted “mode 3” here below).

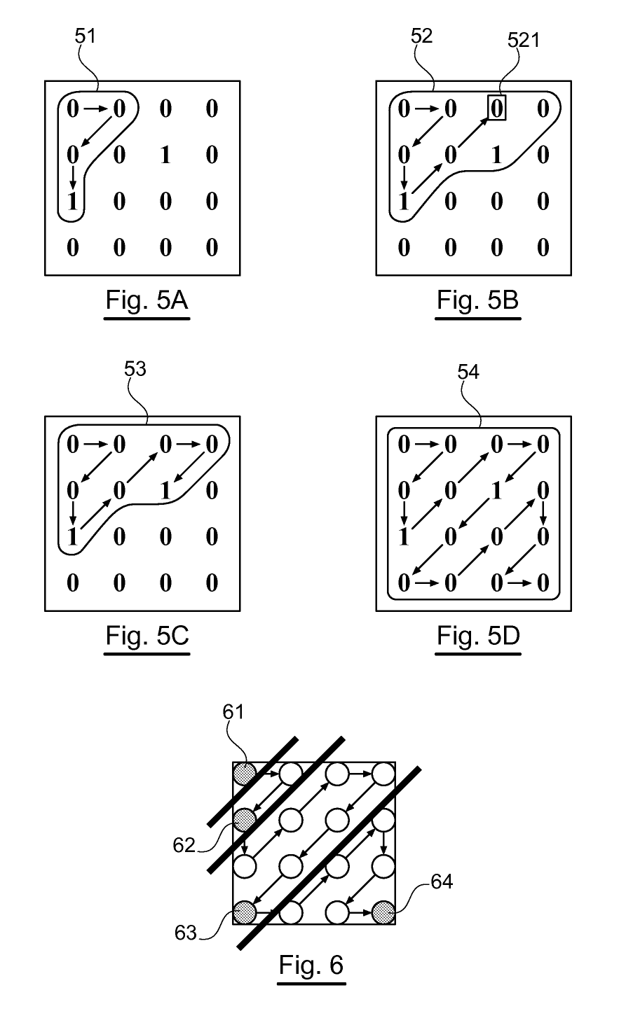

FIGS. 5A to 5D illustrate especially these different series for the encoding of the coefficients of a block during a scanning of the coefficients in the zigzag order as described with reference to the prior art.

FIG. 5A thus presents the encoding of a series of coefficients of the first type according to the “mode 0”. The series 51 in this case comprises a single group. It may be recalled that a “0” signifies that the coefficient is not a newly-significant coefficient (it was encoded at the previous iteration as being a significant coefficient or it was encoded as being a non-significant coefficient and remains non-significant at this current iteration) and that “1” signifies that the coefficient is newly-significant (it was encoded at the previous iteration with a value zero and becomes significant at the current iteration). The series 51 therefore corresponds to the group 0, 0, 0, 1, coefficient sign, coefficient value.

FIG. 5B illustrates the encoding of a series of second type coefficients according to the “mode 2” in taking N to be equal to 6: the series 52 comprises the group including the coefficient located at the position 6 (referenced 521 in FIG. 5B) along the zigzag path of the block, and the group preceding this group in the order of the path, if these groups do not include coefficients already encoded at a preceding iteration.

FIG. 5C illustrates the encoding of a series of first type coefficients according to the “mode 3” in which the series 53 corresponds to M groups of coefficients, with M=2.

Finally, FIG. 5D shows the encoding of a series of coefficient of the first type according to “mode 1”, according to which the series 54 corresponds to all the coefficients of the block considered.

Returning to FIG. 4, once the type of series of coefficients has been selected the encoding method according to this preferred embodiment of the invention, during the encoding step 44 and for a first level of the hierarchical structure in successive layers (first iteration), encodes a series of coefficients of the first block, determined as a function of the type selected, then the second block, and so on and so forth until the last block (45). The operation then passes to a second level of the hierarchical structure in successive layers (second iteration 46) and a new encoding is done of a series of coefficients of the first block, determined as a function of the type selected, and then of the second block and so on and so forth until the last block (45) of the second level. Thus, each layer of data of the hierarchical structure is encoded.

It may be recalled that for the second type of series, if the series comprising the group including the maximum position N has been encoded at a preceding reiteration, the series is empty. If not, the series comprises the group including the predetermined maximum position, and all the preceding groups according to the read scan path (if such groups exist). For the mode 0 and the mode 3, if there no long remain any groups to be encoded, the series is empty.

Once the different levels and the different blocks have been encoded, the encoder of an embodiment of the invention delivers a total data stream 47 in which there is inserted a piece of information representing the type of series of coefficients selected for the image or for an image sequence or for a portion of the image.

Thus, a decoder can read the information representing the type of series of coefficients selected and can automatically adapt to the encoding mode used, especially for the decoding of the refinement layers. An embodiment of the invention thus offers the possibility of having a decoding of low complexity or adaptive complexity.

This piece of information representing the selected type of series of coefficients can also be accompanied by a piece of information on implementation, comprising, for example a vector that defines the value of the number M or the position N for each iteration.

Thus, the encoded data stream 47 can carry two information elements indicating firstly the type of series of coefficients selected, used especially by the decoder for the encoding of the refinement layers and secondly one or more bits for the vector defining the positions of coefficients to be attained at each iteration if the encoding implements mode 2 (in defining the position N) or the number of ranges to be encoded if the encoding implements the mode 3 (in defining the number of groups M).

According to the preferred embodiment of the invention described, these information elements are inserted into the stream 47 in the header of the data packets relative to a temporal image or an image portion (also called a slice), i.e. in the header of the data packets of each layer of the hierarchical structure.

Furthermore, it is also possible to add a parameter, here below called bInterlacedSigRef to the stream 47. This parameter bInterlacedSigRef indicates whether, for a given iteration, groups of significance coefficients and/or groups of refinement coefficients are encoded.

This method is also noteworthy in that it can provide for using only the second type of series to determine the series of coefficients to be encoded.

Referring to Appendix A, which is an integral part of an embodiment of the present invention, an example is now presented of syntax of the header of the scalable images in which the elements inserted into the stream 47 according to an embodiment of the invention are shown in italics. The semantics associated with this syntax is more specifically described in the document “Scalable Video Coding Joint Working Draft 4”, Joint Video Team (JVT) of the ISO/IEC MPEG and ITU-T VCEG, JVT-Q201, October 2005, Nice.

Here below, it is only the structure of the elements inserted into the stream 47 according to the preferred embodiment of the invention that are described:

if( slice_type = = PR ) {

| | | |
|---|---|---|
| fgs_coding_mode | 2 | u(2) |
| if( fgs_coding_mode = = 2 ) { | | |

| | | |
|---|---|---|
| vect4x4_presence_flag | 2 | u(1) |
| vect8x8_presence_flag | 2 | u(1) |
| if( vect4x4_presence_flag ∥ | | |
| vect8x8_presence_flag ) { | | |

| | | |
|---|---|---|
| num_iter_coded | 2 | ue(v) |
| for( i = 0; i < num_iter_coded; | | |
| i ++ ) { | | |

if( vect4x4_presence_flag ) {

| | | |
|---|---|---|
| scanIndex_blk4x4[i] | 2 | ue(v) |

}
if( vect8x8_presence_flag ) {

| | | |
|---|---|---|
| scanIndex_blk8x8[i] | 2 | ue(v) |

}

}

}

}

if( fgs_coding_mode == 3 ) {

| | | |
|---|---|---|
| num_range_coded | 2 | ue(v) |

}

| | | |
|---|---|---|
| interlaced_sig_ref_flag | 2 | u(1) |

}

In particular, the field fgs_coding_mode is used to indicate the type of series of coefficients, selected during the encoding, that the decoder can read during the decoding of the compressed data stream, and especially of the refinement layers.

It is recalled especially that the first type of series determines a series of coefficients comprising a predetermined number M of groups of coefficients: if M=1, this encoding is denoted as “mode 0”; if M comprises the set of the coefficients of the block considered, this encoding is denoted “mode 1”; and if M corresponds to a predetermined integer of, groups of coefficients, this encoding is denoted “mode 3”.

The second type of series (“mode 2”) determines a series of coefficients comprising: the group including the position N and all the groups that precede it along the read scan path (if they exist) if the group comprising the position N has not been encoded at a preceding iteration; if not, it is an empty series.

Using the terms loosely, the notations “mode 0”, “mode 1”, “mode 2”, and “mode 3” also denote the corresponding decoding modes.

Thus, if the field fgs_coding_mode takes the value 0, it means that the encoding is done according to the first type of series of coefficients, according to the “mode 0” type and therefore that the decoding must enable the decoding of one group per block for each of the blocks at each iteration.

The value 1 indicates that the encoding is done according to the first type of series of coefficients, according to “mode 1” and therefore that the decoding must enable the decoding of all the coefficients of each of the block in a single iteration. This “mode 1” corresponds to a low-complexity decoding of the refinement layers where all these groups of a significant type and/or refined type of a block are decoded in one iteration.

The value 2 indicates that the encoding is done according to a second type of series of coefficients, according to the “mode 2” and therefore that the decoding must enable the decoding at each iteration of a set of groups until it reaches a position N, this position N being defined at each iteration by default or by a fixed or variable vector.

Finally, the value 3 indicates that the encoding is done according to the first type of series of coefficients, according to “mode 3” and therefore that the decoding must enable the decoding at each iteration of a number M of groups. This number M may be constant.

The flags vect4×4_presence_flag and vect8×8_presence_flag respectively indicate the presence of vectors defining the maximum position N in the case of mode 2 for blocks sized 4×4 pixels and for blocks sized 8×8 pixels.

More specifically, if the value of a flag is equal to 1, the vector corresponding to this flag is present in the stream.

Furthermore, in the case of mode 2, the variable num_iter_coded indicates the number of values contained in the vector for the 4×4 blocks and/or for the 8×8 blocks. The variable scanIndex_blk4×4[i] indicates the maximum position of a coefficient of an 4×4 block up to which the groups must be decoded at the iteration i. The variable scanIndex_blk8×8[i] indicates the maximum position of a coefficient of an 8×8 block up to which the groups must be decoded at the iteration i.

If the mode is mode 2, and if the vector for a 4×4 block (or respectively an 8×8 block) is not present, this vector is deduced from the vector for an 8×8 block (or 4×4 block respectively) in dividing the values of this vector by 4 (or multiplying the values of this vector by 4 respectively).

If none of the vectors is present, it is chosen to use default vectors with a value [1,3,10,16] for a 4×4 block and [3,10,36,64] for an 8×8 block.

Thus each default value corresponds to a predetermined frequency zone of the blocks of coefficients, the position index ranging from 1 to 16 for the 4×4 blocks and from 1 to 64 for the 8×8 blocks).

FIG. 6 illustrates especially the frequency bands of the default vector considered for a block sized 4×4. The reference 61 thus designates the position 1 according to the zigzag read scan path, the reference 62 illustrates the position 3, the reference 63 illustrates the position 10, and the reference 64 illustrates the position 16, defined in the vector [1,3,10,16].

In the case of the mode 3, the num_range_coded variable indicates the number of ranges or groups to be decoded at each iteration.

Finally, in all the modes 0 to 3 described here above, if the variable interlaced_sig_ref_flag is equal to 1, ranges of significance and ranges of refinement are decoded at each iteration. If, on the contrary, interlaced_sig_ref_flag is equal to 0, ranges of significance or ranges of refinement are decoded at each iteration.

In the latter case, the refinement ranges are decoded only when all the significance ranges of the image have been decoded.

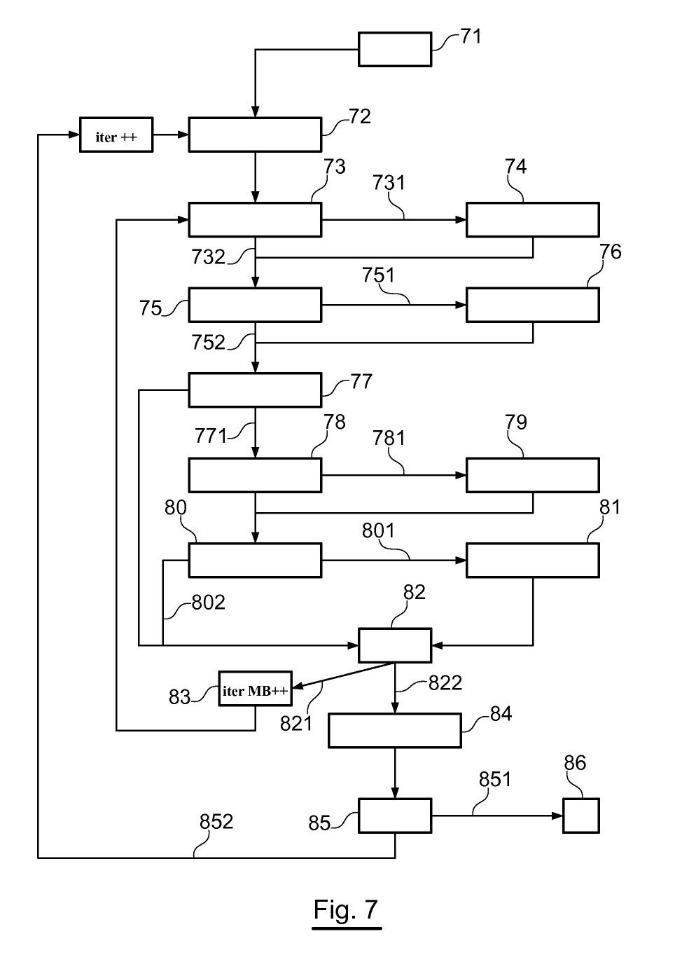

Referring now to FIG. 7, we present the general principle of the decoding method of an embodiment of the invention.

It may be recalled especially that the choice of the decoding method is given by the value fgs_coding_mode which is present in the data stream and which the decoder has just read.

As indicated here above, according to this preferred embodiment of the invention, four modes of decoding refinement layers are singled out, these modes being distinguished by the number of ranges to be decoded at each iteration:
mode 0: at each iteration one range per block is decoded;
mode 1: at each iteration all the ranges of each block are decoded;
mode 2: at each iteration, a number of ranges is decoded until the position N is reached in the block, N being a function of the iteration;
mode 3: at each iteration, a constant number M of ranges is decoded.

First of all, a few notations used here below in the description are introduced:
iter corresponds to the number of iterations performed during the decoding;
completeLumaSig is a Boolean value indicating whether all the significance groups for all the luminance blocks have been decoded;
completeLumaRef is a Boolean value indicating whether all the refinement groups of all the luminance blocks have been decoded;
completeChromaSig is a Boolean value indicating whether all the significance groups of all the chrominance blocks have been decoded;
completeChromaRef is a Boolean value indicating whether all the refinement groups of all the chrominance blocks have been decoded;
bInterlacedChroma is a Boolean value indicating whether groups of chrominance and luminance blocks are decoded during a same iteration;
interlaced_sig_ref_flag is a Boolean value indicating whether the significance and refinement groups are interlaced. Its value is decoded from the stream;
completeLumaSigBl(iBloc) is a Boolean value indicating whether all the significance groups of a luminance block iBloc have been decoded;
completeLumaRefBl(iBloc) is a Boolean value indicating whether all the refinement groups of a luminance block iBloc have been decoded;
completeChromaSigBl(iBloc) is a Boolean value indicating whether all the significance groups of a chrominance block iBloc have been decoded;
completeChromaRefBl(iBloc) is a Boolean value indicating whether all the refinement groups of a chrominance block iBloc have been decoded.

Initialization

During an initialization step 71, the parameter iter takes the value 0, completeLumaSig takes the value FALSE, completeLumaRef takes the value FALSE, completeChromaSig takes the value FALSE, completeChromaRef takes the value FALSE. For all the blocks iBloc of the image completeLumaSigBl(iBloc) takes the value FALSE, completeLumRefBl(iBloc) takes the value FALSE, completeChromaSigBl(iBloc) takes the value FALSE, completeChromaRefBl(iBloc) takes the value FALSE.

The Scanning of the Macro-Blocks

Thereafter, in the step 72, each macro-block of the image is scanned. For each macro-block, the value of the variable completeLumaSig is looked at in a step 73 “Test completeLumaSig”. If the variable completeLumaSig is equal to FALSE (731), then in a step 74, the significance pass is decoded for each luminance block of the macro-block and the operation then goes to the step 75.

When the value of the variable completeLumaSig goes to TRUE (732), the value of the variable interlaced_sig_ref is looked at during a testing step 75 (test interlaced_sig_ref). This test renders the value TRUE (751) if interlaced_sig_ref is equal to TRUE or if completeLumaSig is equal to true and if completeLumaRef is equal to FALSE. If not (752) this test gives FALSE. If the test interlaced_sig_ref is equal to TRUE, the refinement pass is decoded in a step 76 for each luminance block of the macro-block.

Then, the variable bInterlacedChroma is looked at in a testing step 77 test “bInterlacedChroma”. This gives TRUE (771) if bInterlacedChroma is equal to TRUE, and if iterChroma(iter) gives TRUE or if completeLumaSig is equal to TRUE and completeLumaRef is equal to TRUE. If the “test bInterlacedChroma” 77 is equal to FALSE (772), the operation passes to the step 82. If the “test bInterlacedChroma” 77 is equal to TRUE (771), the value of the variable completeChromaSig is considered during a step 78 “Test completeChromaSig”. If completeChromaSig is equal to FALSE (781), then for each chrominance block of the macro-block, the significance pass is encoded during a step 79.

Then, the variable interlaced_sig_ref is tested again during a test step 80. This test gives TRUE (801) if interlaced_sig_ref is equal to TRUE or if completeChromaSig is equal to TRUE, and if completeChromaRef is equal to FALSE. If not (802) this test renders a value FALSE. If the test renders a value TRUE (801) then, during a step 81, the refinement pass is decoded for each chrominance block of the macro-block and then the operation goes to the step 82.

Finally, in a step 82, a test is made to see if the macro-block considered is the last macro-block of the image or of the current portion of the image. If it is not the last (821), than a reiteration (83) is performed on the next macro-block. If the macro-block considered is the last macro-block of the image or of the current portion of the image (822), the operation passes to the step 84 for updating the variable completeSig,Ref. Then the end test is performed 85.

Updating (84) of the Variable completeSig,Ref

The step for updating the variable completeSig, Ref updates the variables completeLumaSig, completeLumaRef, completeChromaSig and completeChromaRef.

More specifically:
completeLumaSig takes the value TRUE if, for all the iBloc blocks of the image, completeLumaSigBl(iBloc) is equal to TRUE;
completeLumaRef takes the value TRUE if, for all the iBloc blocks of the image, completeLumaRefBl(iBloc) is equal to TRUE.
completeChromaSig takes the value TRUE if, for all the iBloc blocks of the image, completeChromaSigBl(iBloc) is equal to TRUE.
completeChromaRef takes the value TRUE if, for all the iBloc blocks of the image, completeChromaRefBl(iBloc) is equal to TRUE.

End Test (85)

The end test gives TRUE (851) if completeLumaSig is equal to TRUE, completeLumaRef is equal to TRUE, completeChromaSig is equal to TRUE, and if completeChromaRef is equal to TRUE. If the end test is equal to FALSE (852) the operation passes to the next iteration (iter++). If not, the decoding ends (86).

Function iterChroma(iter)

This function renders the value TRUE if the luminance and chrominance ranges are interlaced and if, at the iteration iter, chrominance ranges have to be decoded. This function is used to control the interlacing of the chrominance and luminance coefficients.

For example, the JSVM4 encoder/decoder, as defined in the document “Joint Scalable Video Model JSVM-4”, October 2005, Nice, JVT-Q202, proposes to decode a chrominance pass only every three significance decoding passes, giving iterChroma(iter) is equal to TRUE if (iter+offset_iter) modulo 3 is equal to 0. The parameter offset_iter is a parameter used to define the luminance encoding iteration at which the first chrominance encoding iteration will be encoded.

Decoding of Significance and Refinement Passes

It may be recalled first of all that the decoding of groups corresponds:
in the case of a significance pass:
   to the decoding of all the remaining non-significant coefficients positioned between the start of the block (or just after a significant coefficient) and just before the next newly significant coefficient; and
   to the decoding of the next newly significant coefficient;
in the case of a refinement pass:
   to the decoding of the refinement of the already significant coefficient.

The scanning of the coefficients is done in the zigzag order. The decoding of the chrominance blocks and of the luminance blocks is done in the same way.

In the case of the mode 0, for each block, a group is decoded. If the operation is at the end of the block, the Boolean parameter completeCompPassBl of the current block is positioned at TRUE, where variable Comp indicates Luma if the block is a luminance block or Chroma if the block is a chrominance block, and the variable Pass indicates Sig if the decoded pass is a significance pass, and Ref if the decoded pass is a refinement pass.

In the case of the mode 1, for each block, all the groups are decoded and completeCompPassBl of the current block is positioned at TRUE.

In the case of the mode 2, for each block, the maximum position N in the block which is equal to scanIndex_blkkxk[i], where i is the current iteration number and k×k is the type of block (4×4 or 8×8 for a luminance block or 4×4 for a chrominance block). Then, the ranges are decoded so long as the position of the last decoded coefficient is smaller than the position N. If the operation is at the end of the block, completeCompPassBl of the current block is positioned at TRUE.

In the case of the mode 3, for each block, a number of groups equal to num_range_coded (num_range_coded=M) is decoded. If the operation is at the end of the block, completeCompPassBl of the current block is positioned at TRUE.

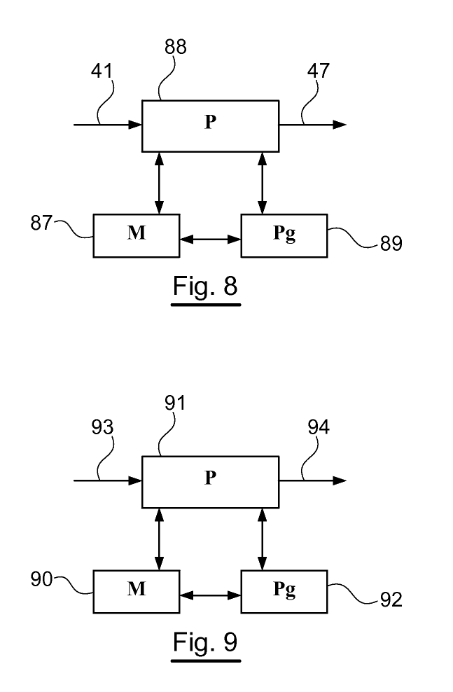

FIG. 8 presents the hardware structure of a device for encoding an image or an image sequence implementing the encoding method described here above.

An encoding device of this kind comprises a memory M 87, a processing unit P 88 equipped for example with a microprocessor μP, and driven by a computer program Pg 89. At initialization, the code instructions of the computer program Pg 89 are for example loaded into a RAM and then executed by the processor of the processing unit P 88. At input, the processing unit P 88 receives video input components 41 (images, image sequences or image portions). The microprocessor μP of the processing unit 88 implements the steps of the encoding method described here above with reference to FIG. 4, according to the instructions of the program Pg 89. The processing unit 88 outputs an encoded data stream 47.

FIG. 9 illustrates the hardware structure of a device for decoding an encoded data stream, generated for example by the encoding device of FIG. 8.

A decoding device of this kind comprises a memory M 90, a processing unit P 91 equipped for example with a microprocessor μP, and driven by the computer program Pg 92. At initialization, the code instructions of the computer program Pg 92 are for example loaded into a RAM and then executed by the processor of the processing unit 91. At input, the processing unit 91 receives a stream of encoded data 93 to be decoded. The microprocessor μP of the processing unit 91 implements the steps of the decoding method described here above with reference to FIG. 7, according to the instructions of the program Pg 92. The processing unit 91 outputs decoded video components 41 (images, image sequences or image portions).

APPENDIX

| slice_header_in_scalable_extension( ) { | | C | Descriptor |
|---|---|---|---|
| | first_mb_in_slice | 2 | ue(v) |
| | slice_type | 2 | ue(v) |
| | if( slice_type = = PR ) { | | |

| | | |
|---|---|---|
| fragmented_flag | 2 | u(1) |
| if ( fragmented_flag = = 1 ) { | | |

| | | |
|---|---|---|
| fragment_order | 2 | ue(v) |
| if ( fragment_order != 0) | | |

| | | |
|---|---|---|
| last_fragment_flag | 2 | u(1) |

}
if ( fragment_order = = 0 ) {

| | | |
|---|---|---|
| num_mbs_in_slice_minus1 | 2 | ue(v) |
| luma_chroma_sep_flag | 2 | u(1) |

}

}
if ( slice_type != PR || fragment_order = = 0 ) {

| | | |
|---|---|---|
| pic_parameter_set_id | 2 | ue(v) |
| frame_num | 2 | u(v) |
| if( !frame_mbs_only_flag ) { | | |

| | | |
|---|---|---|
| field_pic_flag | 2 | u(1) |
| if( field_pic_flag ) | | |

| | | |
|---|---|---|
| bottom_field_flag | 2 | u(1) |

}
if( nal_unit_type = = 21 )

| | | |
|---|---|---|
| idr_pic_id | 2 | ue(v) |

if( pic_order_cnt_type = = 0 ) {

| | | |
|---|---|---|
| pic_order_cnt_lsb | 2 | u(v) |
| if( pic_order_present_flag && !field_pic_flag ) | | |

| | | |
|---|---|---|
| delta_pic_order_cnt_bottom | 2 | se(v) |

}
if( pic_order_cnt_type = = 1 && !delta_pic_order_always_zero_flag ) {

| | | |
|---|---|---|
| delta_pic_order_cnt[ 0 ] | 2 | se(v) |
| if( pic_order_present_flag && !field_pic_flag ) | | |

| | | |
|---|---|---|
| delta_pic_order_cnt[ 1 ] | 2 | se(v) |

}

}
if( slice_type != PR ) {

if( redundant_pic_cnt_present_flag )

| | | |
|---|---|---|
| redundant_pic_cnt | 2 | ue(v) |

if( slice_type = = EB )

| | | |
|---|---|---|
| direct_spatial_mv_pred_flag | 2 | u(1) |

| | | |
|---|---|---|
| base_id_plus1 | 2 | ue(v) |
| if( base_id_plus1 != 0 ) { | | |

| | | |
|---|---|---|
| adaptive_prediction_flag | 2 | u(1) |

}
if( slice_type = = EP || slice_type = = EB ) {

| | | |
|---|---|---|
| num_ref_idx_active_override_flag | 2 | u(1) |
| if( num_ref_idx_active_override_flag ) { | | |

| | | |
|---|---|---|
| num_ref_idx_10_active_minus1 | 2 | ue(v) |
| if( slice_type = = EB ) | | |

| | | |
|---|---|---|
| num_ref_idx_l1_active_minus1 | 2 | ue(v) |

}

| } | |
|---|---|
| ref_pic_list_reordering( ) | 2 |
| if( ( weighted_pred_flag && slice_type = = EP ) \|\| | |

( weighted_bipred_idc = = 1 && slice_type = = EB ) ) {
if( adaptive_prediction_flag)

| | | |
|---|---|---|
| base_pred_weight_table_flag | 2 | u(1) |

if( base_pred_weight_table_flag = = 0 )

pred_weight_table( )

}
if( nal_ref_idc != 0 )

| | |
|---|---|
| dec_ref_pic_marking( ) | 2 |

if( entropy_coding_mode_flag && slice_type != EI )

| | | |
|---|---|---|
| cabac_init_idc | 2 | ue(v) |

}
if ( slice_type != PR || fragment_order = = 0 ) {

| | | |
|---|---|---|
| slice_qp_delta | 2 | se(v) |
| if( deblocking_filter_control_present_flag ) { | | |

| | | |
|---|---|---|
| disable_deblocking_filter_idc | 2 | ue(v) |
| if( disable_deblocking_filter_idc != 1 ) { | | |

| | | |
|---|---|---|
| slice_alpha_c0_offset_div2 | 2 | se(v) |
| slice_beta_offset_div2 | 2 | se(v) |

}

}

}
if( slice_type != PR)

if( num_slice_groups_minus1 > 0 &&

| slice_group_map_type >= 3 && slice_group_map_type <= 5) | | |
|---|---|---|
| slice_group_change_cycle | 2 | u(v) |

if( slice_type != PR && extended_spatial_scalability > 0 ) {

if ( chroma_format_idc > 0 ) {

| | | |
|---|---|---|
| base_chroma_phase_x_plus1 | 2 | u(2) |
| base_chroma_phase_y_plus1 | 2 | u(2) |

}
if( extended_spatial_scalability = = 2 ) {

| | | |
|---|---|---|
| scaled_base_left_offset | 2 | se(v) |
| scaled_base_top_offset | 2 | se(v) |
| scaled_base_right_offset | 2 | se(v) |
| scaled_base_bottom_offset | 2 | se(v) |

}

}
if( slice_type = = PR ) {

| | | |
|---|---|---|
| adaptive_ref_fgs_flag | 2 | u(1) |
| if( adaptive_ref_fgs_flag ) { | | |

| | | |
|---|---|---|
| max_diff_ref_scale_for_zero_base_block | 2 | u(5) |
| max_diff_ref_scale_for_zero_base_coeff | 2 | u(5) |

}

}

if( slice_type = = PR ) {

| | | |
|---|---|---|
| fgs_coding_mode | 2 | u(2) |
| if( fgs_coding_mode = = 2 ) { | | |

| | | |
|---|---|---|
| vect4x4_presence_flag | 2 | u(1) |
| vect8x8_presence_flag | 2 | u(1) |
| if( vect4x4_presence_flag ∥ vect8x8_presence_flag ) { | | |

| | | |
|---|---|---|
| num_iter_coded | 2 | ue(v) |
| for( i = 0; i < num_iter_coded; i ++ ) { | | |

if( vect4x4_presence_flag ) {

| | | |
|---|---|---|
| scanIndex_blk4x4[i] | 2 | ue(v) |

}
if( vect8x8_presence_flag ) {

| | | |
|---|---|---|
| scanIndex_blk8x8[i] | 2 | ue(v) |

}

}

}
}

if( fgs_coding_mode == 3 ) {

| | | |
|---|---|---|
| num_plage_coded | 2 | ue(v) |

}

| | | |
|---|---|---|
| interlaced _sig_ref_flag | 2 | u(1) |

}

SpatialScalabilityType = spatial_scalability_type( )

}

An embodiment of the invention provides a technique of encoding and decoding images and/or video sequences that adapts the complexity to the level of the decoding, as a function of the type of encoding used.

In particular, in the context of an application to the encoding and decoding of scalable video images and/or sequences relying on a layered organization of the streams, an embodiment of the invention provides a technique of this kind that is an improvement of the JSVM model technique proposed by the JVT working group in the document JVT-Q202 by J. Reichel, M. Wien and H. Schwarz, <<Joint Scalable Video Model JSVM-4>>, October 2005, Nice.

An embodiment of the invention spropose a technique of this kind that can be used to preserve the complexity of classic decoding when a truncation of the image is required and to reduce the complexity of decoding when the truncation of the image is not required.

An embodiment of the invention sprovide a technique of this kind that is simple to implement and costs little in terms of resources (such as bandwidth, processing capacities etc) and does not introduce any particular complexity or major processing operations.

Although the present disclosure has been described with reference to one or more examples, workers skilled in the art will recognize that changes may be made in form and detail without departing from the scope of the disclosure and/or the appended claims.

1. Method for encoding an image or a sequence of images, generating a data stream, each image being subdivided into at least two image blocks, wherein each one of which is associated with a transformed block comprising a set of coefficients, said coefficients of a transformed block being distributed in a group or among groups of coefficients according to a predetermined grouping criterion and a predetermined scan path for reading said transformed blocks, wherein the method comprises, for each of said transformed blocks:
encoding a series of coefficients corresponding to at least one group of coefficients, said series being determined as a function of a type of series of coefficients selected from among at least two possible types, including:
a first type of series according to which said series of coefficients comprises a predetermined number M of groups of coefficients,
a second type of series according to which, with a predetermined maximum position N in said scan path being identified, the series comprises the group including said maximum position N and all the preceding groups along said scan path, if there are any, and
inserting into said data stream a piece of information representing said type of series of coefficients selected for said image or sequence of images, or for a portion of said image.

2. Encoding method according to claim 1, wherein said data stream has a hierarchical structure in nested data layers at successive refinement levels, and said method implements an iterative encoding, each of the iterations corresponding to one of said levels and implementing said encoding step.

3. Encoding method according to claim 2, wherein, for said second type of series:
when said series comprising said group including said maximum position N has been encoded at a preceding iteration, said series is empty,
when said series comprising said group including said maximum position N has not been encoded at a preceding iteration, said series comprises the group including said predetermined maximum position and all the preceding groups along said scan path that do not belong to a series already encoded at a preceding iteration, if there are any.

4. Encoding method according to claim 2, wherein each of said iterations implements at least one of the following passes:
a significance pass,
a refinement pass,
said encoding step applying to the pass or passes implemented,
and wherein a parameter indicating the type of said pass or passes implemented accompanies said piece of information representing said type of series of coefficients.

5. Encoding method according to claim 4, wherein when said pass is a significance pass, said predetermined grouping criterion defines a group as a set of successive non-significant coefficients terminating with the first significant coefficient encountered along said read scan path, and when said pass is a refinement pass, said predetermined grouping criterion defines a group as a unique significant coefficient.

6. Encoding method according to claim 2, wherein said piece of information representing said type of series of coefficients is accompanied by a piece of information on implementation, comprising a vector that defines the value of said number M or of said position N for each iteration.

7. Encoding method according to claim 1, wherein a source image is decomposed into at least two components to be encoded, and wherein said encoding is applied to each of said components.

8. Encoding device of an image or a sequence of images, generating a data stream, each image being subdivided into at least two image blocks, wherein each one of which is associated with a transformed block comprising a set of coefficients, said coefficients of a transformed block being distributed in a group or among groups of coefficients according to a predetermined grouping criterion and a predetermined scan path for reading said transformed blocks, wherein the encoding device comprises:
means of encoding a series of coefficients corresponding to at least one group of coefficients, said series being determined as a function of a type of series of coefficients selected from among at least two possible types, including:
a first type of series according to which said series of coefficients comprises a predetermined number M of groups of coefficients,
a second type of series according to which, with a predetermined maximum position N in said scan path being identified, said series comprises the group including said maximum position N and all the preceding groups along said scan path, if there are any,
and means of insertion into said data stream of a piece of information representing said type of series of coefficients selected for said image or sequence of images or for a portion of said image.

9. Encoding device according to claim 8 wherein said stream has a hierarchical structure in nested data layers at successive refinement levels and the encoding means implement an iterative encoding, each of the iterations corresponding to one of said levels, and wherein for said second type of series:
when said series comprising said group including said maximum position N has been encoded at a preceding iteration, said series is empty,
when said series comprising said group including said maximum position N has not been encoded at a preceding iteration, said series comprises the group including said predetermined maximum position and all the preceding groups along said scan path that do not belong to a series already encoded at a preceding iteration, if there are any.

10. Computer program product stored in a computer-readable carrier, wherein the program product comprises program code instructions for implementing, when said program product is executed by a computer, an encoding method for encoding an image or a sequence of images, generating a data stream, each image being subdivided into at least two image blocks, wherein each one of which is associated with a transformed block comprising a set of coefficients, said coefficients of a transformed block being distributed in a group or among groups of coefficients according to a predetermined grouping criterion and a predetermined scan path for reading said transformed blocks, wherein the method comprises, for each of said transformed blocks:
encoding a series of coefficients corresponding to at least one group of coefficients, said series being determined as a function of a type of series of coefficients selected from among at least two possible types, including:
a first type of series according to which said series of coefficients comprises a predetermined number M of groups of coefficients,
a second type of series according to which, with a predetermined maximum position N in said scan path being identified, the series comprises the group including said maximum position N and all the preceding groups along said scan path, if there are any, and
inserting into said data stream a piece of information representing said type of series of coefficients selected for said image or sequence of images, or for a portion of said image.

11. Method for decoding a data stream representing an image or a sequence of images, each image being subdivided into at least two image blocks, wherein each one of which is associated with a transformed block comprising a set of coefficients, said coefficients of a transformed block being distributed in a group or among groups of coefficients according to a predetermined grouping criterion and a predetermined scan path for reading said transformed blocks, wherein the method comprises:
reading a type of series of coefficients applied to said image or sequence of images, or an image portion, from at least two possible types, including:
a first type of series according to which said series of coefficients comprises a predetermined number M of groups of coefficients,
a second type of series according to which, with a predetermined maximum position N in the scan path being identified, said series comprises the group including said maximum position N and all the preceding groups along said scan path, if there are any,
decoding taking account, for each transformed block, of a series of coefficients according to the type of series of coefficients delivered by said reading step.

12. Decoding method according to claim 11, wherein said data stream has a hierarchical structure in nested data layers at successive refinement levels, said stream having undergone an iterative encoding, each of the iterations corresponding to one of said levels, and wherein, for the second type of series:
when said series comprising said group including said maximum position N has been encoded at a preceding iteration, said series is empty,
when said series comprising said group including said maximum position N has not been encoded at a preceding iteration, said series comprises the group including said predetermined maximum position and all the preceding groups along said scan path that do not belong to a series already encoded at a preceding iteration, if there are any.

13. Device for the decoding of data stream representing an image or a sequence of images, each image being subdivided into at least two image blocks, wherein each one of which is associated with a transformed block comprising a set of coefficients, said coefficients of a transformed block being distributed in a group or among groups of coefficients according to a predetermined grouping criterion and a predetermined scan path for reading said transformed blocks, wherein the device comprises:
means of reading a type of series of coefficients applied to said image or sequence of images, or to an image portion, from at least two possible types, including:
a first type of series according to which said series of coefficients comprises a predetermined number M of groups of coefficients,
a second type of series according to which, with a predetermined maximum position N in said scan path being identified, said series comprises the group including said maximum position N and all the preceding groups along said scan path, if there are any, and
decoding means taking account, for each transformed block, of a series of coefficients according to the type of series of coefficients delivered by said read step.

14. Decoding device according to claim 13, wherein said data stream has a hierarchical structure in nested data layers at successive refinement levels, said stream having undergone an iterative encoding, each of the iterations corresponding to one of said levels, and wherein, for said second type of series:
when said series comprising said group including said maximum position N has been encoded at a preceding iteration, said series is empty,
when said series comprising said group including said maximum position N has not been encoded at a preceding iteration, said series comprises the group including said predetermined maximum position and all the preceding groups along said scan path that do not belong to a series already encoded at a preceding iteration, if there are any.

15. Computer program product stored in a computer-readable carrier, wherein the program product comprises program code instructions for implementing, when said program product is executed by a computer, a decoding method for decoding a data stream representing an image or a sequence of images, each image being subdivided into at least two image blocks, wherein each one of which is associated with a transformed block comprising a set of coefficients, said coefficients of a transformed block being distributed in a group or among groups of coefficients according to a predetermined grouping criterion and a predetermined scan path for reading said transformed blocks, wherein the method comprises:
reading a type of series of coefficients applied to said image or sequence of images, or an image portion, from at least two possible types, including:
a first type of series according to which said series of coefficients comprises a predetermined number M of groups of coefficients,
a second type of series according to which, with a predetermined maximum position N in the scan path being identified, said series comprises the group including said maximum position N and all the preceding groups along said scan path, if there are any,
decoding taking account, for each transformed block, of a series of coefficients according to the type of series of coefficients delivered by said reading step.

16. Signal stored on a computer-readable memory and representing a data stream, representing an image or a sequence of images, each image being subdivided into at least two image blocks, wherein each one of which is associated a transformed block comprising a set of coefficients, said coefficients of a transformed block being distributed in a group or among groups of coefficients according to a predetermined grouping criterion and a predetermined scan path for reading said transformed blocks, wherein the signal carries a piece of information representing a type of series of coefficients applied to said image or sequence of images, or to a portion of said image, from at least two possible types, including:
a first type of series according to which said series of coefficients comprises a predetermined number M of groups of coefficients,
a second type of series according to which, with a predetermined maximum position N in the scan path being identified, said series comprises the group including said maximum position N and all the preceding groups along said scan path, if there are any.

17. Signal according to claim 16, wherein said data stream has a hierarchical structure in nested data layers at successive refinement levels, said stream having undergone an iterative encoding, each of the iterations corresponding to one of said levels, and wherein, for said second type of series:
when said series comprising said group including said maximum position N has been encoded at a preceding iteration, said series is empty,
when said series comprising said group including said maximum position N has not been encoded at a preceding iteration, said series comprises the group including said predetermined maximum position and all the preceding groups along said scan path that do not belong to a series already encoded at a preceding iteration, if there are any.
